(19) United States
(12) Patent Application Publication
(10) Pub. No.: US 2026/0142078 A1
(43) Pub. Date: May 21, 2026

(54) COMPOSITE ELECTRONIC COMPONENT

(71) Applicant: SAMSUNG ELECTRO-MECHANICS CO., LTD., Suwon-si (KR)

(72) Inventors: So Eun CHOI, Suwon-si (KR); Jong Ho LEE, Suwon-si (KR); Chae Min PARK, Suwon-si (KR); So Jung AN, Suwon-si (KR); Yoo Jeong LEE, Suwon-si (KR); Jung Won PARK, Suwon-si (KR)

(73) Assignee: SAMSUNG ELECTRO-MECHANICS CO., LTD., Suwon-si (KR)

(21) Appl. No.: 19/361,524

(22) Filed: Oct. 17, 2025

(30) Foreign Application Priority Data
Nov. 20, 2024 (KR) 10-2024-0166397

(51) Int. Cl. H01G 2/06; H01G 4/12; H01G 4/232; H01G 4/248; H01G 4/30

(52) U.S. Cl. CPC H01G 2/065; H01G 4/12; H01G 4/2325; H01G 4/248; H01G 4/30

(57) ABSTRACT

A composite electronic component includes a body including a dielectric layer and an internal electrode alternately disposed with the dielectric layer, and a capacitor including an external electrode disposed on the body, and a bump disposed on a lower surface of the body, the bump connected to the external electrode. The bump includes a bump body including a conductive metal, a Ni plating layer disposed on the bump body, a compound layer disposed on the Ni plating layer, and a Sn plating layer disposed on the compound layer. One or more surfaces, among a surface of the Ni plating layer adjacent to the bump body and a surface of the Ni plating layer adjacent to the compound layer, have surface roughness.

### CROSS-REFERENCE TO RELATED APPLICATION(S)

This application claims benefit of priority to Korean Patent Application No. 10-2024-0166397 filed on Nov. 20, 2024 in the Korean Intellectual Property Office, the disclosure of which is incorporated herein by reference in its entirety.

### TECHNICAL FIELD

The present disclosure relates to a composite electronic component.

A multilayer ceramic capacitor (MLCC) is a chip-type condenser mounted on the printed circuit boards of various types of electronic products such as imaging devices, including a liquid crystal display (LCD) and a plasma display panel (PDP), computers, smartphones, mobile phones, and onboard chargers (OBCs) or DC-DC converters of electric vehicles, and serves to charge or discharge electricity therein or therefrom.

A dielectric layer, included in a MLCC, may have piezoelectric and electrostrictive properties. Accordingly, when a direct current (DC) or alternating current (AC) voltage is applied to the MLCC, a piezoelectric phenomenon may occur between internal electrodes, resulting in vibrations.

Such vibrations may be transferred, through an external electrode of the MLCC, to a printed circuit board on which the MLCC is mounted, thereby generating vibration sound. The vibration sound may fall within an audible frequency range of 20 Hz to 20,000 Hz, which can cause discomfort to human listeners. This type of vibration sound may be referred to as acoustic noise.

In the related art, various methods have been used to reduce acoustic noise. The methods may include techniques such as varying thicknesses of an upper cover portion and a lower cover portion of a body, bonding an interposer including a ceramic material to a lower portion of a capacitor, or bonding a metal bump to the lower portion of the capacitor.

In particular, in a structure such as that disclosed in Related Art Document 1, in which a metal bump is bonded to a lower portion of a capacitor, a reflow process may be performed for junction between the capacitor and the metal bump. During this process, a Sn plating layer of the capacitor and a Sn plating layer of the metal bump may melt and form a Sn bulk. This may lead to difficulties in achieving uniform soldering, and may also hinder the formation of efficient bonding force between a Ni plating layer of the metal bump and the Sn bulk.

### Prior Art Document

### Patent Document

Patent Document 1: JP 2022-081609 A

### SUMMARY

An aspect of the present disclosure is to mitigate an issue such as insufficient bonding force between a capacitor and a bump.

However, the aspects of the present disclosure are not limited to those set forth herein, and will be more easily understood in the course of describing specific example embodiments of the present disclosure.

According to an aspect of the present disclosure, there is provided a composite electronic component including a capacitor including a body including a dielectric layer and internal electrodes alternately disposed with the dielectric layer, and an external electrode disposed on the body, and a bump disposed on a first surface of the body, the bump connected to the external electrode. The bump may include a bump body including a conductive metal, a Ni plating layer disposed on the bump body, a compound layer disposed on the Ni plating layer, and a Sn plating layer disposed on the compound layer. The Ni plating layer has a first surface adjacent to the bump body and a second surface adjacent to the compound layer, and one or more surfaces selected from the first surface of the Ni plating layer and the second surface of the Ni plating layer have surface roughness.

According to example embodiments of the present disclosure, interfacial bonding force between a capacitor and a bump may be improved.

However, the various and beneficial advantages and effects of the present disclosure are not restricted to those set forth herein, and will be more easily understood in the process of describing specific example embodiments.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a composite electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic enlarged view of region “P1” of FIG. 2;

FIG. 5 is a schematic enlarged view of region “P2” of FIG. 2;

FIG. 6 is a schematic enlarged view of region “P3” of FIG. 2; and

FIG. 7 is a schematic diagram of a method of measuring a ten-point average surface roughness (Rz) of a first bump compound layer according to an example embodiment.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a lamination direction or a thickness direction, a second direction may be defined as a length direction, and a third direction may be defined as a width direction.

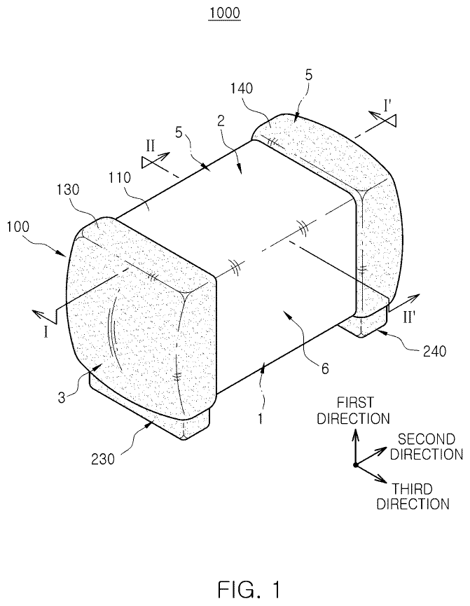

FIG. 1 is a schematic perspective view of a composite electronic component according to an example embodiment of the present disclosure.

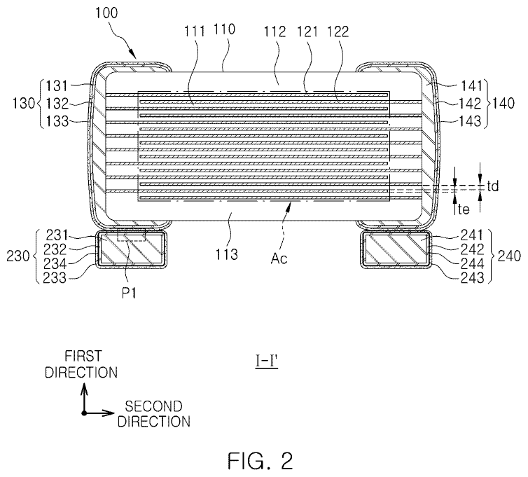

FIG. 2 is a schematic cross-sectional view taken along line I-I′ of FIG. 1.

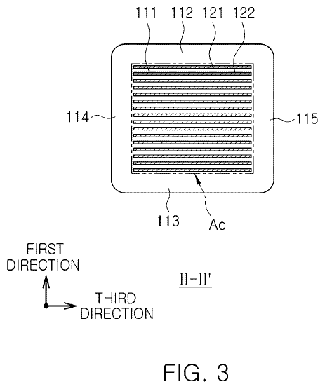

FIG. 3 is a schematic cross-sectional view taken along line II-II′ of FIG. 1.

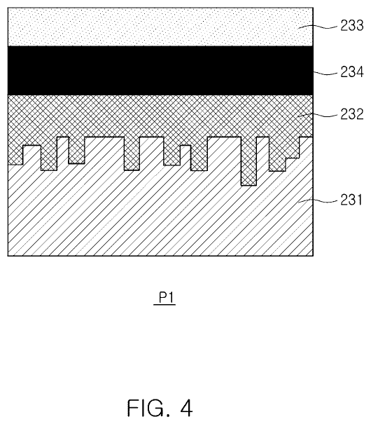

FIG. 4 is a schematic enlarged view of region “P1” of FIG. 2 according to an embodiment of the present application.

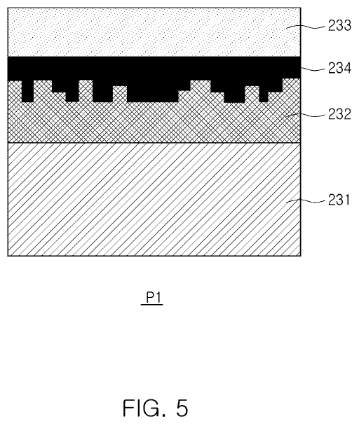

FIG. 5 is a schematic enlarged view of region “P1” of FIG. 2 according to another embodiment of the present application.

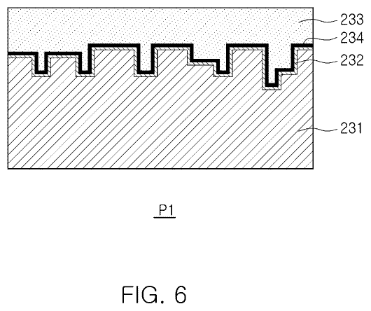

FIG. 6 is a schematic enlarged view of region “P1” of FIG. 2 according to yet another embodiment of the present application.

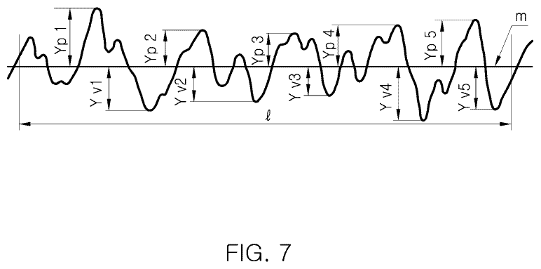

FIG. 7 is a schematic diagram of a method of measuring a ten-point average surface roughness (Rz) of a first bump compound layer according to an example embodiment.

Hereinafter, a composite electronic component 1000 according to an example embodiment of the present disclosure, and various examples thereof will be described in detail with reference to FIGS. 1 to 7.

A composite electronic component 1000 according to an example embodiment of the present disclosure may include a capacitor 100 including a body 110 including a dielectric layer 111 and internal electrodes 121 and 122 alternately disposed with the dielectric layer, and external electrodes 130 and 140 disposed on the body, and bumps 230 and 240 disposed on a lower surface of the body, the bumps 230 and 240 connected to the external electrodes. The bumps may include bump bodies 231 and 241 including a conductive metal, Ni plating layers 232 and 242 respectively disposed on the bump bodies, compound layers 234 and 244 respectively disposed on the Ni plating layers, and Sn plating layers 233 and 243 respectively disposed on the compound layers. One or more surfaces, among a surface of each of the Ni plating layers adjacent to the bump bodies and a surface of each of the Ni plating layers adjacent to the compound layers, may have surface roughness.

The capacitor 100 may include the body 110 and the external electrodes 130 and 140 disposed on the body.

The body 110 may include the dielectric layer 111 and the internal electrodes 121 and 122. The dielectric layer 111 and the internal electrodes 121 and 122 may be alternately disposed in a first direction. That is, in the present disclosure, the first direction may refer to a lamination direction of the dielectric layer 111 and the internal electrodes 121 and 122.

A specific shape of the body 110 is not limited. However, as illustrated in FIG. 1, the body 110 may have a hexahedral shape or a shape similar thereto. During a sintering process, ceramic powder particles, included in the body 110, may shrink, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in a second direction, perpendicular to the first direction, and fifth and sixth surfaces 5 and 6 connected to the third and fourth surfaces 3 and 4, the fifth and sixth surfaces 5 and 6 opposing each other in a third direction, perpendicular to the first and second directions.

As margin regions in which the internal electrodes 121 and 122 are not disposed on the dielectric layer 111 overlap each other, a step portion may occur due to thicknesses of the internal electrodes 121 and 122, such that an edge, connecting a first surface and third to sixth surfaces to each other, and/or an edge, connecting a second surface and the third to sixth surfaces to each other, may shrink toward a central portion of the body 110 in the first direction, with respect to the first surface or the second surface. Alternatively, due to a shrinkage behavior of the body during a sintering process, an edge, connecting the first surface 1 and the third to sixth surfaces 3, 4, 5, and 6 to each other, and/or an edge, connecting the second surface 2 and the third to sixth surfaces 3, 4, 5, and 6 to each other, may shrink toward the central portion of the body 110 in the first direction, with respect to the first surface or the second surface. Alternatively, in order to prevent chipping defects, an additional process may be performed to round edges connecting respective surfaces of the body 110 to each other. Accordingly, the edge, connecting the first surface and the third to sixth surfaces to each other, and/or the edge, connecting the second surface and the third to sixth surfaces to each other, may have a round shape.

A plurality of dielectric layers 111, included in the body 110, may be in a sintered state, and adjacent dielectric layers 111 may be integrated with each other such that boundaries therebetween are not readily apparent without using a scanning electron microscope (SEM). The number of laminated dielectric layers is not particularly limited, and may be determined in consideration of a size of the composite electronic component. For example, the body may be formed by laminating 400 or more dielectric layers.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not particularly limited as long as sufficient capacitance is obtainable therewith, and may be, for example, barium titanate-based (BaTiO₃)-based powder particles. As a more specific example, the barium titanate-based (BaTiO₃)-based powder particles may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and CaZrO₃-based paraelectric powder particles may be (Ca₁₋ₓSrₓ)(Zr_{1-y}Ti_{y})O₃ (0<x<1, 0<y<1).

An average thickness (td) of the dielectric layer 111 is not limited.

In order to more easily achieve high capacitance and miniaturization of the composite electronic component 1000, the average thickness (td) of the dielectric layer 111 may be 0.35 μm or less. In order to improve reliability of the composite electronic component 1000 under high temperature and high pressure conditions, the average thickness (td) of the dielectric layer 111 may be 3 μm or more.

The average thickness (td) of the dielectric layer 111 may refer to an average thickness of one or more dielectric layers, among the plurality of dielectric layers.

The average thickness (td) of the dielectric layer 111 may be measured by scanning, with an SEM, an image of a cross-section of the body 110 in the first and second directions (L-T cross-section). For example, dielectric layers may be extracted from an SEM image of a cross-section in the first and second directions (L-T cross-section) obtained by cutting a central portion of the body 110 in a width direction. With respect to one dielectric layer, among the dielectric layers, adjacent to a point at which a central line of the capacitance formation portion in a length direction and a central line of the capacitance formation portion in a thickness direction meet each other, the average thickness (td) may be an average value of thicknesses measured at 1/4, 2/4, and 3/4 positions of the dielectric layer in the length direction. When such average value measurement is performed on two upper dielectric layers and two lower dielectric layers, equally spaced apart from the one dielectric layer adjacent to the point at which the central line of the capacitance formation portion in the length direction and the central line of the capacitance formation portion in the thickness direction meet each other, the average thickness of the dielectric layer may be further generalized.

With respect to a total of five dielectric layers including one dielectric layer at a reference point at which a central line of the body in the length direction and a central line of the body in the thickness direction meet each other, two dielectric layers above the one dielectric layer, and two dielectric layer below the one dielectric layer, five points, including the reference point, two left points relative to the reference point, and two right points relative to the reference point, may be set to be equally spaced apart from each other, and then thicknesses of respective points may be measured to obtain an average value thereof.

The body 110 may include a capacitance formation portion Ac disposed in the body 110, in which capacitance is formed by alternately laminating a first internal electrode 121 and a second internal electrode 122 with the dielectric layer 111, and cover portions 112 and 113 disposed on upper and lower portions of the capacitance formation portion Ac in the first direction.

The capacitance formation portion Ac may be a portion contributing to the formation of capacitance in the capacitor, and may be formed by repeatedly laminating a plurality of first and second internal electrodes 121 and 122 with the dielectric layer 111 interposed therebetween. The capacitance formation portion Ac may refer to a region in which the first and second internal electrodes 121 and 122 overlap in the first direction. In addition, the first internal electrode 121 may be disposed on an uppermost end of the capacitance formation portion Ac in the first direction, and the second internal electrode 122 may be disposed on a lowermost end of the capacitance formation portion Ac in the first direction.

The internal electrodes 121 and 122 may include the first internal electrode 121 and the second internal electrode 122. The first and second internal electrodes 121 and 122 may be alternately disposed to oppose each other with the dielectric layer 111, included in the body 110, interposed therebetween, and may respectively be exposed to the third and fourth surfaces 3 and 4 of the body 110. That is, in an example embodiment, one end of the first internal electrode 121 in the second direction may be in contact with the third surface 3, and one end of the second internal electrode 122 in the second direction may be in contact with the fourth surface 4.

Referring to FIG. 2, the first internal electrode 121 may be connected to the first external electrode 130, and the second internal electrode 122 may be connected to the second external electrode 140.

The first internal electrode 121 may be connected to the first external electrode 130 without being connected to the second external electrode 140, and the second internal electrode 122 may be connected to the second external electrode 140 without being connected to the first external electrode 130. That is, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

A conductive metal, included in the internal electrodes 121 and 122, may be one or more of Ni, Cu, Pd, Ag, Au, Pt, In, Sn, Al, Ti, and alloys thereof, and the present disclosure is not limited thereto.

An average thickness (te) of each of the internal electrodes 121 and 122 is not limited, and may vary depending on a purpose thereof. In order to achieve miniaturization of the composite electronic component 1000, the average thickness (te) of each of the internal electrodes 121 and 122 may be 0.35 μm or less. In order to improve reliability of the composite electronic component 1000, the average thickness (te) of each of the internal electrodes 121 and 122 may be 3 μm or more under high temperature and high pressure conditions.

The average thickness (te) of each of the internal electrodes 121 and 122 may refer to an average thickness of at one or more internal electrodes, among a plurality of internal electrodes.

The average thickness (te) of each of the internal electrodes 121 and 122 may be measured by scanning, with the SEM, the image of the cross-section of the body 110 in the first and second directions (L-T cross-section). For example, internal electrodes may be extracted from an SEM image of a cross-section in the first and second directions (L-T cross-section) obtained by cutting the central portion of the body 110 in the width direction. With respect to one internal electrode, among the internal electrodes, adjacent to the point at which the central line of the capacitance formation portion in the length direction and the central line of the capacitance formation portion in the thickness direction meet each other, the average thickness (te) may be an average value of thicknesses measured at 1/4, 2/4, and 3/4 positions of the internal electrode in the length direction. When such average value measurement is performed on two upper internal electrodes and two lower internal electrodes, equally spaced apart from the one internal electrode adjacent to the point at which the central line of the capacitance formation portion in the length direction and the central line of the capacitance formation portion in the thickness direction meet each other, the average thickness of the internal electrode may be further generalized.

With respect to a total of five internal electrodes including one internal electrode at a reference point at which a central line of the body in the length direction and a central line of the body in the thickness direction meet each other, among internal electrodes extracted from the SEM image of the cross-section in the length and thickness directions (L-T cross-section) obtained by cutting the central portion of the body 110 in the width direction, two internal electrodes above the one internal electrode, and two internal electrode below the one internal electrode, five points, including the reference point, two left points relative to the reference point, and two right points relative to the reference point, may be set to be equally spaced apart from each other, and then thicknesses of respective points may be measured to obtain an average value thereof.

Referring to FIGS. 2 and 3, cover portions 112 and 113 may be disposed on upper and lower surfaces of the capacitance formation portion Ac in the first direction.

The cover portions 112 and 113 may basically serve to prevent damage to the internal electrode due to physical or chemical stress.

The cover portions 112 and 113 may include a material the same as that of the dielectric layer 111. That is, the cover portions 112 and 113 may include a ceramic material, and may include, for example, a barium titanate (BaTiO₃)-based ceramic material.

An average thickness of each of the cover portions 112 and 113 is not limited. For example, each of the cover portions 112 and 113 may have a thickness of 20 μm or less.

The average thickness of each of the cover portions 112 and 113 may refer to a size of each of the cover portions 112 and 113 in the first direction, and may be an average value of sizes of each of the cover portions 112 and 113 in the first direction, measured at five equally spaced points in an upper portion or lower portion of the capacitance formation portion Ac.

Referring to FIG. 3, margin portions 114 and 115 may be disposed on side surfaces of the capacitance formation portion Ac.

The margin portions 114 and 115 may include a first margin portion 114 disposed on the fifth surface 5 of the body 110, and a second margin portion 115 disposed on the sixth surface 6 of the body 110. That is, the margin portions 114 and 115 may be disposed on both end surfaces of the ceramic body 110 in the width direction.

As illustrated in FIG. 3, the margin portions 114 and 115 may refer to regions between both ends of the first and second internal electrodes 121 and 122 and a boundary surface of the body 110 in a cross-section of the body 110 in a width-thickness (W-T) direction.

The margin portions 114 and 115 may basically serve to prevent damage to the internal electrode due to physical or chemical stress.

The margin portions 114 and 115 may be formed by forming an internal electrode by coating a conductive paste on a ceramic green sheet, except for a portion of the ceramic green sheet on which a margin portion is to be formed.

A width of each of the margin portions 114 and 115 is limited. For example, an average width of each of the margin portions 114 and 115 may be 20 μm or less.

The average width of each of the margin portions 114 and 115 may refer to an average size of a region, in which the internal electrode is spaced apart from the fifth surface, in the third direction, and an average size of a region, in which the internal electrode is spaced apart from the sixth surface, in the third direction, and may be an average value obtained by averaging sizes of each of the margin portions 114 and 115 in the third direction, measured at five equally spaced points in an side surface of the capacitance formation portion Ac.

The external electrodes 130 and 140 may be disposed on the body 110, and specifically, on the third and fourth surfaces 3 and 4 of the body 110.

The external electrodes 130 and 140 may include a first external electrode 130 disposed on the third surface 3 of the body 110, and a second external electrode 140 disposed on the fourth surface 4 of the body 110.

It is not necessary to limit the external electrodes 130 and 140 to being disposed only on the third surface 3 and the fourth surface 4 of the body. Referring to FIGS. 1 and 2, the first external electrode 130 may be disposed to extend to portions of the first, second, fifth and sixth surfaces 1, 2, 5, and 6 from the third surface 3 of the body 110, and the second external electrode 140 may be disposed to extend to portions of the first, second, fifth and sixth surfaces 1, 2, 5, and 6 from the fourth surface 4 of the body 110.

The external electrodes 130 and 140 may include electrode layers 131 and 141 disposed on the body 110, the electrode layers 131 and 141 connected to the internal electrodes 121 and 122.

Specifically, the first external electrode 130 may include a first electrode layer 131 disposed on the body 110, the first electrode layer 131 connected to the first internal electrode 121, and the second external electrode 140 may include a second electrode layer 141 disposed on the body 110, the second electrode layer 141 connected to the second internal electrode 122.

The first and second electrode layers 131 and 141 may be respectively connected to the internal electrodes 121 and 122 to secure electrical connectivity between the external electrodes 130 and 140 and the internal electrodes 121 and 122.

The first electrode layer 131 and the second electrode layer 141 may include a conductive metal. A material having excellent electrical conductivity may be used as the conductive metal, and is not limited. For example, the conductive metal may be one or more of nickel (Ni), copper (Cu), and an alloy thereof, and the electrode layers 131 and 141 may include Cu to secure electrical conductivity and bonding force through alloy formation with an Ni internal electrode.

As a specific example of the first and second electrode layers 131 and 141, the electrode layer may be a sintered electrode including a conductive metal and glass, or a resin-based electrode including a conductive metal and a resin.

The first and second electrode layers 131 and 141 may have a form in which the sintered electrode and the resin-based electrode are sequentially formed on the body. In addition, the electrode layers may be formed by transferring a sheet including a conductive metal onto the body or by transferring a sheet including a conductive metal onto the sintered electrode.

A plating layer may be disposed on the electrode layers 131 and 141. The plating layer may serve to improve sealing and mounting properties of the composite electronic component 1000, and may serve to improve bonding force with the bumps 230 and 240 to be described below. A specific structure of the plating layer will be described below.

Referring to FIG. 2, the bumps 230 and 240 may be disposed on a lower surface of the capacitor 100, and may be connected to the external electrodes 130 and 140. The bumps 230 and 240 may be disposed on the lower surface of the capacitor 100 to reduce or absorb vibrations transferred from a substrate to the capacitor 100.

The bumps 230 and 240 may include an element that does not melt even during a solder reflow process, and a plurality of layers may be formed to facilitate adhesion to the capacitor 100.

According to an example embodiment of the present disclosure, the bumps 230 and 240 may include bump bodies 231 and 241 including a conductive metal, and a type of conductive metal included in the bump bodies 231 and 241 is not limited, but the bump bodies 231 and 241 may include Cu as the conductive metal in terms of improving vibration absorption properties.

The bumps 230 and 240 according to an example embodiment may serve as electrodes themselves, and thus may have excellent electrical conductivity. Specifically, the bump bodies 231 and 241 may be substantially formed solely of a conductive metal. For example, the bump bodies 231 and 241 may include Cu and O, but a content of O, included in the bump bodies 231 and 241, may be 0.01 at% or less relative to Cu. The content of Cu and O may be obtained from scanning electron microscopy-energy dispersive x-ray spectroscopy (SEM-EDS). Other methods and/or tools appreciated by one of ordinary skill in the art, even if not described in the present disclosure, may also be used.

In the related art in which the capacitor 100 and the bumps 230 and 240 are connected to each other, a method may be used in which a Sn plating layer is formed on the capacitor 100 and the bumps 230 and 240 and then melted through a reflow process. In this case, the Sn plating layer formed on the capacitor and the Sn plating layer formed on the bumps may be melted together to form a bulk, thereby bonding the capacitor 100 and the bumps 230 and 240 to each other. However, during the reflow process, it may be difficult to uniformly melt the Sn plating layers formed on the capacitor 100 and the bumps 230 and 240. In addition, bonding force between the Sn layer, formed as the bulk, and a Ni plating layer included in the bumps 230 and 240 may be insufficient, making it difficult to achieve sufficient bonding force between the capacitor 100 and the bumps 230 and 240.

Accordingly, in an example embodiment of the present disclosure, the bumps 230 and 240 may include bump bodies 231 and 241 including a conductive metal, Ni plating layers 232 and 242 disposed on the bump bodies 231 and 241, compound layers 234 and 244 disposed on the Ni plating layers 232 and 242, and Sn plating layers 233 and 243 disposed on the compound layers 234 and 244. One or more surfaces, among a surface of each of the Ni plating layers 232 and 242 adjacent to the bump bodies 231 and 241 and a surface of each of the Ni plating layers 232 and 242 adjacent to the compound layers 234 and 244, may have surface roughness, thereby improving bonding force between electrode layers included in the bumps 230 and 240, and improving bonding force between the bumps 230 and 240 and the capacitor 100.

In the present disclosure, the expression that a specific surface “has a roughened texture” may mean that the surface has a level of surface roughness sufficient to maintain interlayer bonding force even after a heat treatment process, such as reflow, at about 270° C. Specifically, the expression may refer to a case in which a ten-point average roughness (Rz) of the surface is 1.3 μm or more. The ten-point average roughness (Rz) may be measured by a profilometer and/or a microscope. Other methods and/or tools appreciated by one of ordinary skill in the art, even if not described in the present disclosure, may also be used.

The compound layers 234 and 244 may be formed by a reaction between portions of the Ni plating layers 232 and the Sn plating layers 233. Accordingly, in an example embodiment, the compound layers 234 and 244 may include an intermetallic compound (IMC) including Ni and Sn.

The external electrodes 130 and 140 of the capacitor 100 may include electrode layers 131 and 141 in contact with one ends of the internal electrodes 121 and 122, Ni plating layers 132 and 142 disposed on the electrode layers 131 and 141, and Sn plating layers 133 and 143 disposed on the Ni plating layers 132 and 142.

The Ni plating layers 132 and 142 may serve to relieve interlayer stress of the external electrodes 130 and 140 and improve sealing properties.

The Sn plating layers 133 and 143 may improve mounting properties, and may form a junction with the bumps 230 and 240. Specifically, the Sn plating layers 133 and 143 of the external electrodes 130 and 140 may be in contact with the Sn plating layers 233 and 243 of the bumps 230 and 240.

Hereinafter, various example embodiments in which one or more surfaces, among a surface of each of the Ni plating layers 232 and 242 adjacent to the bump bodies 231 and 241 and a surface of each of the Ni plating layers 232 and 242 adjacent to the compound layers 234 and 244, have surface roughness will be described in detail with reference to FIGS. 4 to 6. However, the present disclosure is not limited to the example embodiments according to FIGS. 4 to 6.

Referring to FIG. 4, a surface of the Ni plating layer 232, adjacent to the bump body 231, may have surface roughness.

A method of forming the surface of the Ni plating layer 232, adjacent to the bump body 231, to have surface roughness is not limited. For example, a surface of the bump body 231 may be etched using a physical or chemical method, such that the surface of the Ni plating layer 232, adjacent to the bump body 231, may have surface roughness. More specifically, a physical polishing method (grinding or polishing) using a chemical etching abrasive may be used.

The compound layer 234, formed by a reaction between portions of the Ni plating layer 232 and the Sn plating layer 233, may be formed between the Ni plating layer 232 and the Sn plating layer 233. Accordingly, bonding force between the Ni plating layer 232 and the Sn plating layer 233 may be relatively favorable. An alloy may be partially formed between the bump body 231 and the Ni plating layer 232 depending on an element of the bump body 231. However, unless an intermetallic compound is formed, it may be difficult to secure sufficient bonding force between the bump body 231 and the Ni plating layer 232. In addition, due to low bonding force between the bump body 231 and Ni plating layer 232, it may be difficult to maintain bonding between the capacitor 100 and the bumps 230 and 240 during the reflow process of the composite electronic component.

However, according to an example embodiment, when the surface of the Ni plating layer 232, adjacent to the bump body 231, has surface roughness, the above-described issue, caused by low bonding force between the Ni plating layer 232 and the bump body 231, may be mitigated. As a result, sufficient bonding force between the capacitor 100 and the bumps 230 and 240 may be secured.

Referring to FIG. 4, a ten-point average roughness of the surface of the Ni plating layer 232, adjacent to the bump body 231, may be greater than a ten-point average roughness of a surface of the Ni plating layer 232, adjacent to the compound layer 234. In this case, even when only the surface of the bump body 231 has surface roughness, sufficient bonding force between the capacitor 100 and the bumps 230 and 240 may be secured. Thus, an additional surface roughness formation process may not be performed.

Referring to FIG. 5, the surface of the Ni plating layer 232, adjacent to the compound layer 234, may have surface roughness.

A structure in which the surface of the Ni plating layer 232, adjacent to the compound layer 234, has surface roughness may be induced by forming the compound layer 234 after a surface of the Ni plating layer 232 having surface roughness. In this case, separation between the Ni plating layer 232 and the compound layer 234 may be prevented, thereby improving internal bonding force of the bumps 230 and 240.

A method of forming the surface of the Ni plating layer 232, adjacent to the compound layer 234, to have surface roughness is not limited. For example, before forming the Ni plating layer 232, the surface of the bump body 231 may be etched using a physical or chemical method, such that the surface of the Ni plating layer 232, adjacent to the compound layer 234, may have surface roughness. More specifically, a physical polishing method (grinding or polishing) using a chemical etching abrasive may be used.

Referring to FIG. 6, both the surface of the Ni plating layer 232, adjacent to the bump body 231, and the surface of the Ni plating layer 232, adjacent to the compound layer 234, may have surface roughness.

A method of forming the surface of the Ni plating layer 232, adjacent to the bump body 231, and the surface of the Ni plating layer 232, adjacent to the compound layer 234, to have surface roughness is not limited.

Before forming the Ni plating layer 232, the surface of the bump body 231 may be etched using a physical or chemical method, such that the surface of the Ni plating layer 232, adjacent to the bump body 231, may have surface roughness. Thereafter, when a condition, such as plating time of the Ni plating layer 232, is adjusted, the surface of the Ni plating layer 232, adjacent to the bump body 231, and the surface of the Ni plating layer 232, adjacent to the compound layer 234, may be formed to have surface roughness, as illustrated in FIG. 6. The compound layer 234 may be formed by forming the Sn plating layer 233 on the Ni plating layer 232, performing a reflow process, or performing a heat treatment process.

Both the surface of the Ni plating layer 232, adjacent to the bump body 231, and the surface of the Ni plating layer 232, adjacent to the compound layer 234, may have surface roughness. The compound layer 234 may be formed on the Ni plating layer 232. Both a surface of the compound layer 234, adjacent to the Ni plating layer 232, and a surface of the compound layer 234, adjacent to the Sn plating layer 233, may have surface roughness. The compound layer 234 may be formed by adjusting a temperature or process time in a reflow process or heat treatment process such that both the surface of the compound layer 234, adjacent to the Ni plating layer 232, and the surface of the compound layer 234, adjacent to the Sn plating layer 233, have surface roughness. As described, when both the surface of the compound layer 234, adjacent to the Ni plating layer 232, and the surface of the compound layer 234, adjacent to the Sn plating layer 233, are formed to have surface roughness, all interfaces of the bump body 231, the Ni plating layer 232, the compound layer 234, and the Sn plating layer 233 may have surface roughness, thereby more significantly improving bonding force between the bumps 230 and 240 and the capacitor 100.

Referring to FIG. 6, the compound layer 234 may be formed to have a small thickness along the surface roughness of the Ni plating layer 232. In an example embodiment, the compound layer 234 may be disposed to cover the Ni plating layer 232, thereby further improving bonding force between the bumps 230 and 240 and the capacitor 100.

As a specific example of the compound layer 234 being disposed to cover the Ni plating layer 232, the compound layer 234 may have a connectivity of 95% or more. In this case, the connectivity of the compound layer 234 may refer to a ratio of a sum of lengths of the compound layers 234 formed in a specific region in a second direction, to a length of the specific region in the second direction. The specific region may refer to a 2/5 region, a 3/5 region, or a 4/5 region, among five equally divided regions of the compound layer 234 positioned on an upper surface or lower surface of each of the bumps 230 and 240, in a cross-section in the first and second directions obtained by polishing the composite electronic component to a central portion of the composite electronic component in the third direction, but the present disclosure is not limited thereto. The specific region may also be selected from the compound layer 234 positioned on side surfaces of the bumps 230 and 240. The lengths may be obtained using an optical microscope or an electron microscope. Other methods and/or tools appreciated by one of ordinary skill in the art, even if not described in the present disclosure, may also be used.

In the present specification, the ten-point average roughness (Rz) may be calculated, as illustrated in FIG. 7. Specifically, five highest peaks and five lowest valleys of an extracted portion for a reference length l may be identified. Thereafter, an absolute value of a sum (Yp1+Yp2+Yp3+Yp4+Yp5) of distances from a mean line m to the five highest peaks and an absolute value of a sum (Yv1+Yv2+Yv3+Yv4+Yv5) of distances from the mean line m to the five lowest valleys may be added together, and this result may be divided by 5 to obtain the ten-point average roughness (Rz).

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are merely used to describe a specific example embodiment, and are not intended to limit the present disclosure. Singular forms may include plural forms as well unless the context clearly indicates otherwise.

While example embodiments have been shown and described above, it will be apparent to those skilled in the art that modifications and variations could be made without departing from the scope of the present disclosure as defined by the appended claims.

What is claimed is:

1. A composite electronic component comprising:
a capacitor including:
a body including a dielectric layer and internal electrodes alternately disposed with the dielectric layer; and
an external electrode disposed on the body; and
a bump disposed on a first surface of the body, the bump connected to the external electrode,
wherein the bump includes:
a bump body including a conductive metal,
a Ni plating layer disposed on the bump body,
a compound layer disposed on the Ni plating layer, and
a Sn plating layer disposed on the compound layer, and
the Ni plating layer has a first surface adjacent to the bump body and a second surface adjacent to the compound layer, and
one or more surfaces selected from the first surface of the Ni plating layer and the second surface of the Ni plating layer have surface roughness.

2. The composite electronic component of claim 1, wherein a ten-point average roughness of the one or more surfaces having surface roughness is 1.3 μm or more.

3. The composite electronic component of claim 1, wherein a ten-point average roughness of the first surface of the Ni plating layer is greater than a ten-point average roughness of the second surface of the Ni plating layer.

4. The composite electronic component of claim 1, wherein a ten-point average roughness of the second surface of the Ni plating layer is greater than a ten-point average roughness of the first surface of the Ni plating layer.

5. The composite electronic component of claim 1, wherein both the first surface of the Ni plating layer and the second surface of the Ni plating layer have surface roughness.

6. The composite electronic component of claim 5, wherein the compound layer has a first surface adjacent to the Ni plating layer, and a second surface adjacent to the Sn plating layer, and
both the first surface of the compound layer and the second surface of the compound layer have surface roughness.

7. The composite electronic component of claim 5, wherein the compound layer covers the Ni plating layer.

8. The composite electronic component of claim 5, wherein a connectivity of the compound layer is 95% or more.

9. The composite electronic component of claim 1, wherein the compound layer includes an intermetallic compound including Ni and Sn.

10. The composite electronic component of claim 1, wherein
the external electrode includes:
an electrode layer in contact with one end of an internal electrode among the internal electrodes,
a Ni plating layer disposed on the electrode layer, and
a Sn plating layer disposed on the Ni plating layer, and
the Sn plating layer of the external electrode and the Sn plating layer of the bump are in contact with each other.

11. The composite electronic component of claim 1, wherein the bump body includes Cu.

12. The composite electronic component of claim 1, wherein
the bump body includes Cu and O, and
a content of O is 0.01 at% or less relative to Cu.

13. The composite electronic component of claim 1, wherein the first surface of the Ni plating layer has surface roughness, and a ten-point average roughness of the first surface of the Ni plating layer is 1.3 μm or more.

14. The composite electronic component of claim 1, wherein the second surface of the Ni plating layer has surface roughness, and a ten-point average roughness of the second surface of the Ni plating layer is 1.3 μm or more.

15. The composite electronic component of claim 14, wherein the second surface of the Ni plating layer has a recessed portion, and the compound layer is disposed in the recessed portion.

16. The composite electronic component of claim 1, wherein a surface of the bump body has surface roughness.

17. The composite electronic component of claim 16, wherein the surface of the bump body has a recessed portion, and the Ni plating layer is disposed in the recessed portion.

18. The composite electronic component of claim 17, wherein both the Ni plating layer and the compound layer conform to peaks and valleys on the surface of the bump body.
